(19) United States
(12) Patent Application Publication
(10) Pub. No.: US 2009/0007232 A1
(43) Pub. Date: Jan. 1, 2009

(54) Information processing system and information processing apparatus

(75) Inventor: Kiyoshi Kasatani, Kanagawa (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/149,215

(22) Filed: Apr. 29, 2008

(30) Foreign Application Priority Data
Jun. 27, 2007 (JP) 2007-169791

(51) Int. Cl. H04L 9/32

(52) U.S. Cl. 726/2

(57) ABSTRACT

A disclosed information processing system includes an authentication information acquisition unit that acquires first authentication information and second authentication information different from the first authentication information. An authentication reference information storage unit stores first authentication reference information for authentication of the first authentication information and second authentication reference information for authentication of the second authentication information. A first authentication determination unit determines success or failure of first authentication using the first authentication information and the first authentication reference information. A second authentication determination unit determines success or failure of second authentication using the second authentication information and the second authentication reference information. An authentication information control unit stores the second authentication reference information and the first authentication information in the authentication reference information storage unit so as to correspond to each other when the first and second authentications are successful.

### BACKGROUND OF THE INVENTION

1. Field of the Invention

The present invention relates to an information processing system and an information processing apparatus.

2. Description of the Related Art

In recent years and continuing to the present, information processing systems have been developed that include a document input/output apparatus which is connected to a network, uses plural communication protocols, and is capable of communicating documents in various data formats with plural information equipment sets.

Such information processing systems provide various application services using the document input/output apparatus as a core. The various application services refer, for example, to transmitting scanned document images and data generated by the information equipment set to a predetermined destination by email or facsimile or transferring files to the information equipment set. In addition, they refer to recording and outputting, for example, text information and images of attached files of received emails or transmitting them to a designated facsimile machine, transferring files to the information equipment set, accumulating and managing data in the apparatus, etc.

However, such a document input/output apparatus is required to be connected to the plural information equipment sets via a network. Particularly, if there are plural of the independent equipment sets required to be authenticated in the network, a user name and a password have to be input for each equipment set in a case where the equipment provides a function of identifying an individual so that only a registered user is permitted to use the equipment, which in turn adversely affects the handling of the apparatus. Furthermore, if the systems of the independent equipment are integrated with each other, it is made possible to use the equipment with a single user name and a single password. However, it costs an enormous amount to develop a system that collectively manages authentication information that has been independently managed.

In order to solve the above problem, the invention in Patent Document 1 discloses a document input/output apparatus that provides a function in which individuals are identified according to the authentication of an operating unit so that only a registered user can use the apparatus. It also discloses a network communication system composed of plural external equipment sets that are connected via a network and identify individuals using protocols on the network so as to provide functions.

According to the invention in Patent Document 1, it is possible to provide the document input/output apparatus compatible with the external equipment that automatically authenticates each of the equipment sets only with the single authentication of the operating unit instead of the authentication of authentication units independently provided.

Patent Document 1: JP-A-2007-67830

### SUMMARY OF THE INVENTION

Meanwhile, in information processing apparatuses shared by plural persons such as multi function peripherals (MFPs) used in schools, companies, etc., it is cumbersome for users to input a password or the like every time they use the apparatuses. Therefore, instead of inputting the password or the like, it is expected the authentication structure to be changed so that they can input data with a simple operation using an authentication IC card or biometrics as represented by fingerprint authentication or the like.

However, the invention in Patent Document 1 does not disclose changing the authentication structure with such a predetermined authentication structure taking over.

Accordingly, the present invention has been made to solve the above drawbacks and may provide an information processing system and an information processing apparatus capable of readily changing an authentication structure.

To this end, according to one aspect of an embodiment of the present invention, an information processing system capable its function being used when authentication is successful is provided. The system comprises an authentication information acquisition unit that acquires first authentication information and second authentication information different from the first authentication information; an authentication reference information storage unit that stores first authentication reference information for authentication of the first authentication information and second authentication reference information for authentication of the second authentication information; a first authentication determination unit that determines success or failure of first authentication using the first authentication information and the first authentication reference information; a second authentication determination unit that determines success or failure of second authentication using the second authentication information and the second authentication reference information; and an authentication information control unit that stores the second authentication reference information and the first authentication information in the authentication reference information storage unit so as to correspond to each other when the first authentication and the second authentication are successful.

Furthermore, according to the information processing system of the embodiment of the present invention, when the second authentication information is acquired by the authentication information acquisition unit in a case where the authentication reference information storage unit does not store the second authentication reference information, the authentication information control unit stores information corresponding to the second authentication reference information generated based on the acquired second authentication information in the authentication reference information storage unit as the second authentication reference information.

Furthermore, according to the information processing system of the embodiment of the present invention, the first authentication determination unit determines the success or failure of the first authentication based on one of the first authentication information acquired by the authentication information acquisition unit and the first authentication information stored in the authentication reference information storage unit corresponding to the second authentication reference information.

Furthermore, according to the information processing system of the embodiment of the present invention, the first authentication determination unit prevents using the first authentication information acquired by the authentication information acquisition unit when the second authentication reference information and the first authentication information are stored in the authentication reference information storage unit so as to correspond to each other.

Furthermore, according to the information processing system of the embodiment of the present invention, the authentication information control unit stores a function added during the first authentication in the authentication information storage unit so as to correspond to the first authentication reference information.

Furthermore, the information processing system is provided that includes an information processing apparatus and external equipment connected to the information processing apparatus via a network. The external equipment has a first authentication information storage unit that is included in the authentication information storage unit and stores the first authentication reference information; and the first authentication determination unit, and the information processing apparatus has the authentication information acquisition unit; a first authentication information storage unit that is included in the authentication information storage unit and stores the first authentication reference information; the second authentication determination unit; and the authentication information control unit.

Furthermore, the information processing system according to the embodiment of the present invention further comprises an IC card reader for reading information recorded on an IC card. The first authentication information acquired by the authentication acquisition unit is authentication information recorded on the IC card.

Furthermore, according to the information processing system of the embodiment of the present invention, the second authentication information acquired by the authentication acquisition unit is information of an input user name and/or a password.

Furthermore, according to another aspect of the embodiment of the present invention, an information processing apparatus is provided that is connected to external equipment for determining success or failure of authentication via a network and can use a function of the external equipment when the authentication is successful. The apparatus comprises an authentication information acquisition unit that acquires first authentication information and second authentication information different from the first authentication information; a transmission and reception unit that transmits the first authentication information to the external equipment and receives information related to success or failure of first authentication based on the first authentication information from the external equipment; an authentication information storage unit that stores second authentication reference information for authentication of the second authentication information; a second authentication determination unit that determines success or failure of second authentication using the second authentication information and the second authentication reference information; and an authentication information control unit that stores the second authentication reference information and the first authentication information in the authentication reference information storage unit so as to correspond to each other when the first authentication and the second authentication are successful.

Furthermore, according to still another aspect of the embodiment of the present invention, an information processing apparatus having a function used when authentication is successful is provided. The apparatus comprises an authentication information acquisition unit that acquires first authentication information and second authentication information different from the first authentication information; a first authentication determination unit that determines success or failure of first authentication using the first authentication information and first authentication reference information; a second authentication determination unit that determines success or failure of second authentication using the second authentication information and second authentication reference information; and an authentication information control unit that stores the second authentication reference information and the first authentication information in an authentication reference information storage unit so as to correspond to each other when the first authentication and the second authentication are successful.

According to the embodiment of the present invention, it is possible to provide an information processing system and an information processing apparatus capable of readily changing an authentication structure.

Other objects, features and advantages of the present invention will become more apparent from the following detailed description when read in conjunction with the accompanying drawings.

### BRIEF DESCRIPTION OF THE DRAWINGS

FIG. 1 is a system configuration diagram including a digital color complex machine according to an embodiment of the present invention;

FIG. 2 is an external perspective view schematically showing the digital color complex machine;

FIG. 3 is a block diagram showing electrical connections between units of the digital color complex machine;

FIG. 4 is a block diagram showing the functional configuration of the digital color complex machine in the embodiment;

FIGS. 5A through 5C are tables showing examples of authentication setting information stored in an authentication setting information unit;

FIGS. 6A and 6B are tables showing private setting information stored in a private setting information unit;

FIG. 7 is a flowchart showing a first example of the authentication operation of the digital color complex machine in the embodiment;

FIG. 8 is a flowchart showing a second example of the authentication operation of the digital color complex machine in the embodiment

FIG. 9 is a flowchart showing an example of first authentication of the digital color complex machine in the embodiment; and

FIG. 10 is a flowchart showing an example of second authentication of the digital color complex machine in the embodiment.

### DETAILED DESCRIPTION OF THE PREFERRED EMBODIMENTS

Referring to the accompanying drawings, a description is made of the best mode for carrying out an embodiment of the present invention. In the embodiment, an information processing apparatus according to the present invention is applied to a so-called digital color complex machine in which are integrated a copy function, a facsimile (FAX) function, a print function, a scanner function, a distribution function that distributes input images (document images scanned by the scanner function and images input by the copy function or the facsimile function), and the like.

(Example of System Configuration)

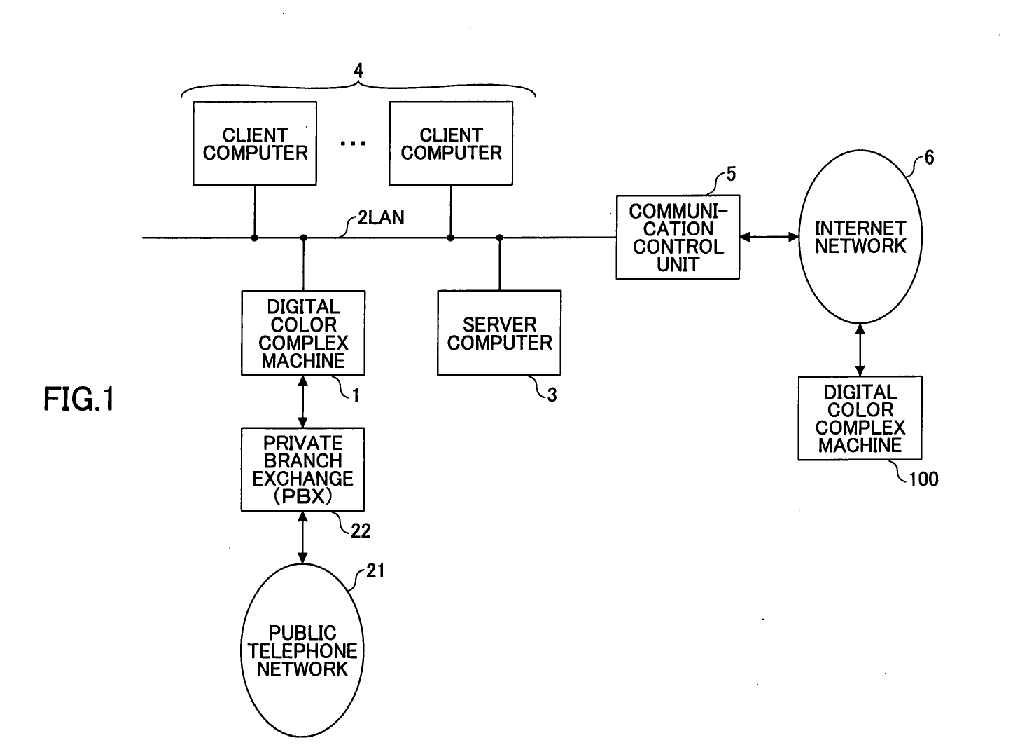

FIG. 1 is a system configuration diagram including the digital color complex machine according to the embodiment. As shown in FIG. 1, the embodiment assumes a system in which the digital color complex machine 1 as an information processing system is connected to a server computer 3 that executes various information processing programs and plural client computers 4 via a LAN (local area network) 2. The server computer 3 supports, for example, a FTP or a HTTP protocol and realizes the functions of a Web server and a DNS (domain name service) server. In other words, this system creates an environment in which image processing functions such as an image input function (scanner function), an image output function (print function), and an image accumulation function provided in the digital color complex machine 1 can be shared on the LAN 2.

Such a system is developed so as to be connected to an Internet network 6 via a communication control unit 5 and be capable of communicating data with an external environment via the Internet network 6. Furthermore, the Internet network 6 is connected to a digital color complex machine 100 having the same function as the digital color complex machine 1.

As the communication control unit 5, routers, switching equipment, modems, DSL modems, etc., are generally used, but the communication control unit 5 may only have a function capable of performing at least TCP/IP communications. Furthermore, the LAN 2 is not limited to wired communications in its form, but it may be wireless communications (such as infrared rays and electromagnetic waves).

(Example of the Digital Color Complex Machine 1)

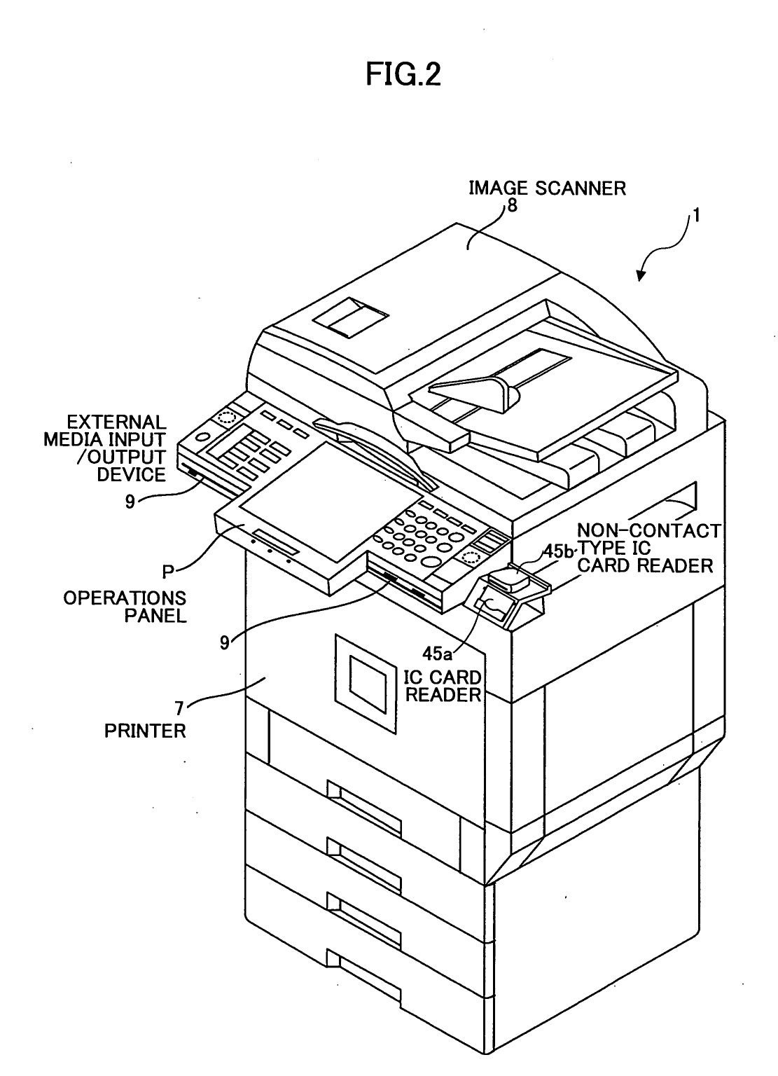

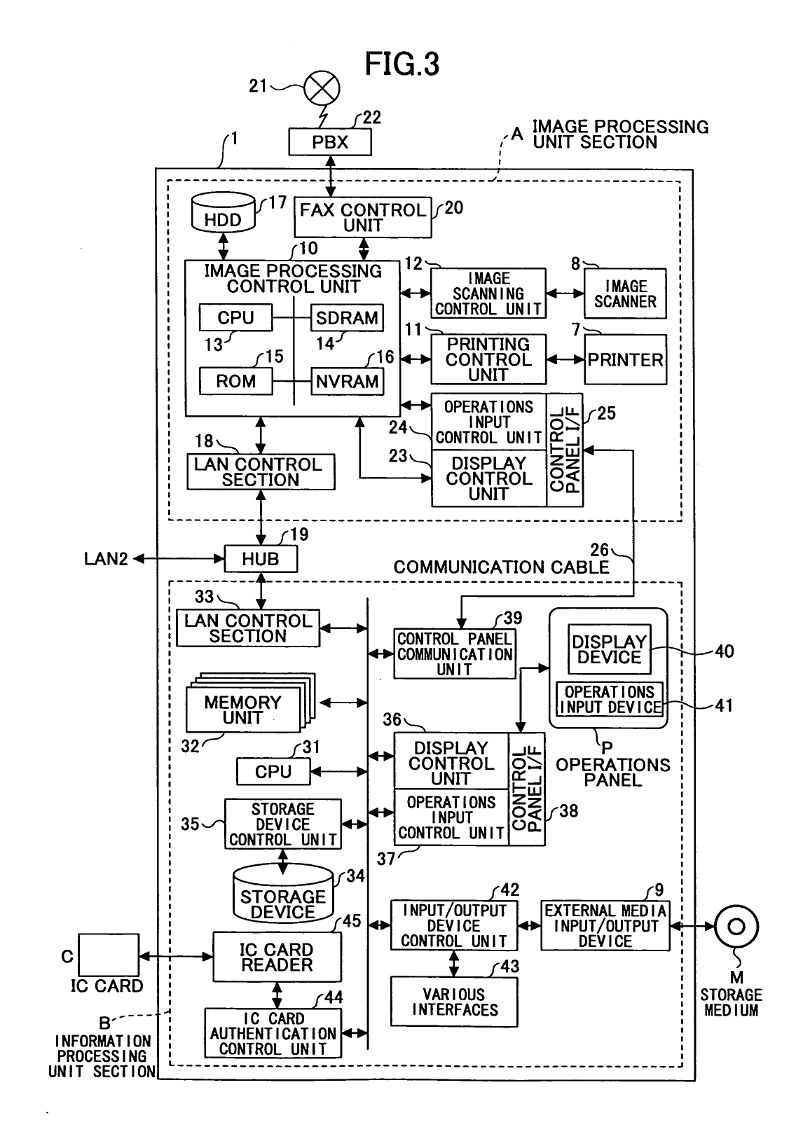

Next, the digital color complex machine 1 is described. Note, however, that the description of the digital color complex machine 1 is also applied to the digital color complex machine 100. Here, FIGS. 2 and 3 are an external perspective view schematically showing the digital color complex machine 1 and a block diagram showing electrical connections between the units of the digital color complex machine 1, respectively.

As shown in FIG. 2, the digital color complex machine 1 has an image scanner 8 for scanning images from a document on the upper side of a printer 7 that forms images on a medium such as transfer paper. Furthermore, at the external surface of the image scanner 8 is provided an operations panel P that offers an operator a display and allows the operator to make various inputs such as function settings. On the lower side of the operations panel P is provided an external media input/output device 9 that reads a program code from a storage medium M or writes a program code, image data, and the like in the storage medium M (see FIG. 3) such as optical disks and flexible disks. The external media input/output device 9 is provided such that the inserting ports, where the insertion of the storage medium M is allowed, are exposed to the outside.

Furthermore, the digital color complex machine 1 shown in FIG. 2 is provided with a contact type IC card reader 45a and a non-contact type IC card reader 45b (hereinafter collectively referred to as an IC card reader 45).

An IC card C (see FIG. 3), which is inserted in the contact type IC card reader 45a to be used (or inserted in the non-contact type IC card reader 45b to be used), is distributed for each operator of, for example, the digital color complex machine 1 and stores authentication information or the like for specifying the operator. The authentication information or the like recorded on the IC card C is read by the contact type IC card reader 45a (or the non-contact type IC card reader 45b), thereby allowing the use of the digital color complex machine 1 within the range of an operator's authority granted corresponding to the authentication information.

As shown in FIG. 3, the digital color complex machine 1 is roughly divided into an image processing unit section A and an information processing unit section B in its basic configuration. The printer 7 and the image scanner 8 belong to the image processing unit section A. On the other hand, the operations panel P, the external media input/output device 9, and the IC card reader 45 belong to the information processing unit section B.

First, the image processing unit section A is described. The image processing unit section A shown in FIG. 3, which is provided with the printer 7 and the image scanner 8, includes an image processing control unit 10 that controls all the image processing in the image processing unit section A. The image processing control unit 10 is connected to a printing control unit 11 that controls the printer 7 and an image scanning control unit 12 that controls the image scanner 8.

The printing control unit 11 outputs printing instructions including image data to the printer 7 in accordance with the control by the image processing control unit 10, thereby causing the printer 7 to form and output images on a medium such as transfer paper. The printer 7 is capable of performing full-color printing, and it can employ various printing methods such as electrophotographic methods, ink jet methods, sublimation-type thermal transfer methods, silver halide photographic methods, direct heat-sensitive recording methods, and melting-type thermal transfer methods.

The image scanning control unit 12 drives the image scanner 8 under the control of the image processing control unit 10, scans reflected light of lamp irradiation with respect to the front surface of a document by condensing it on a light receiving element (for example, a CCD (Charge Coupled Device)) through a mirror and a lens, and applies A/D conversion to analog digital data produced by the CCD so as to generate digital image data in eight-bit color of each RGB.

The image processing control unit 10 is composed of a microcomputer in which a central processing unit (CPU) 13 as a main processor, a synchronous dynamic random access memory (SDRAM) 14 where image data read out from the image scanner 8 are temporarily stored to be used for image formation by the printer 7, a read only memory (ROM) 15 where control programs and the like are stored, and a nonvolatile random access memory (NVRAM) 16 that stores system logs, system settings, log information, and the like and is capable of holding data even when power is turned off. These components are connected to one another through a bus.

Furthermore, the image processing control unit 10 is connected to a hard disk drive (HDD) 17 as a storage device that accumulates a large amount of image data, job history, and the like; a LAN control section 18 that connects the image processing unit section A to the LAN 2 via a HUB 19 as a line concentrator provided in the digital color complex machine 1; and a FAX control unit 20 that controls facsimile transmission/reception. The FAX control unit 20 is connected to a private branch exchange (PBX) 22 communicating with a public telephone network 21. Thus, the digital color complex machine 1 is capable of communicating with remote facsimile machines via the public telephone network 21.

In addition, the image processing control unit 10 is connected to a display control unit 23 and an operations input control unit 24. The display control unit 23 outputs an image display control signal to the information processing unit section B via a communication cable 26 connected to a control panel interface (I/F) 25 under the control of the image processing control unit 10, thereby controlling the image display relative to the operations panel P of the information processing unit section B.

Furthermore, the operations input control unit 24 inputs an input control signal corresponding to function settings and input operations by an operator through the operations panel P of the information processing unit section B via the communication cable 26 connected to the control panel I/F 25 under the control of the image processing control unit 10. In other words, the image processing unit section A is capable of directly monitoring the operations panel P of the information processing unit section B via the communication cable 26.

Thus, the image processing unit section A is configured to have the communication cable 26 connected to the image processing unit of a conventional image processing apparatus so as to use the operations panel P of the information processing unit section B. In other words, the display control unit 23 and the operations input control unit 24 of the image processing unit section A are connected to the operations panel P.

With these configurations, the image processing unit section A analyzes print data and print commands as image information from the outside (the server computer 3, the client computers 4, the facsimile machine, and the like shown in FIG. 1), develops as output image data the print data into bitmap data so as to be printed, and analyzes a print mode based on the commands to determine its operation. The image processing unit section A receives the print data and the commands via the LAN control section 18 or the FAX control unit 20 to operate.

The image processing unit section A is capable of transferring to the outside (the server computer 3, the client computers 4, the facsimile machine, and the like) print data, scanned document data, output image data processed for output, and compressed data thereof, which are stored in the SDRAM 14 and the HDD 17.

Moreover, the image processing unit section A transfers scanned image data of the image scanner 8 to the image processing control unit 10 to correct signal degradation caused by the quantization in an optical system and a digital signal and writes the corrected image data in the SDRAM 14. The image data thus stored in the SDRAM 14 are converted into output image data by the printing control unit 11 and output to the printer 7.

Next, the information processing unit section B including the operations panel P is described. As shown in FIG. 3, the information processing unit section B is composed of a microcomputer controlled by a universal operating system (OS) for use in an information processing apparatus generally called a personal computer. The information processing unit section B includes a CPU 31 as a main processor, and the CPU 31 is connected to a memory unit 32 and a storage device control unit 35 through a bus. The memory unit 32 is composed of a RAM as a work area for the CPU 31 and a ROM storing a boot program and the like. The storage device control unit 35 controls input/output of data to/from the storage device 34 such as a HDD storing an OS and application programs.

Furthermore, the CPU 31 is connected to a LAN control section 33 that connects the information processing unit section B to the LAN 2 via the HUB 19. The IP address as a network address allocated to the LAN control section 33 is different from that allocated to the LAN control section 18 of the image processing unit section A. In other words, two IP addresses are allocated to the digital color complex machine 1 of the embodiment. That is, the LAN 2 is connected to each of the image processing unit section A and the information processing unit section B, thereby making it possible to exchange data between the image/information processing unit sections A and B.

Note that because the digital color complex machine 1 is connected to the LAN 2 via the HUB 19, it seems that only one IP address is allocated to the digital color complex machine 1 in appearance. Accordingly, it is made possible to facilitate the handling of lines without spoiling the beauty of the digital color complex machine 1.

Moreover, the CPU 31 is connected to a display control unit 36 that controls the operations panel P, an operations input control unit 37, and an IC card authentication control unit 44. The operations panel P is composed of a display device 40 such as a liquid crystal display (LCD) and an operations input device 41. The operations input device 41 is composed of a touch panel (not shown) of an ultrasonic elastic wave system or the like that is laminated on the front surface of the display device 40 and a keyboard (not shown) having plural keys.

The keyboard is provided with a start key to start scanning images or the like, a numeric keypad to input numbers, a scanning condition setting key to set a destination of scanned image data, a clear key, and the like. In other words, the display control unit 36 outputs an image display control signal to the display device 40 via the control panel I/F 38 and causes the display device 40 to display given images in accordance with the image display control signal.

On the other hand, the operations input control unit 37 receives an input control signal in accordance with function settings and inputting operations by an operator through the operations input device 41 via the control panel I/F 38. The IC card authentication control unit 44 causes the IC card reader 45 to read authentication information or the like recorded on the IC card C held by the user and allows the use of the digital color complex machine 1 within the range of the user's authority granted corresponding to the read authentication information or the like.

In addition, the CPU 31 is connected to a control panel communication unit 39 connected to the control panel I/F 25 of the image processing unit section A via the communication cable 26. The control panel communication unit 39 receives the image display control signal output from the image processing unit section A. Furthermore, the control panel communication unit 39 transfers an input control signal in accordance with function settings and inputting operations by an operator through the operations panel P to the image processing unit section A. As described in detail below, the image display control signal from the image processing unit section A received at the control panel communication unit 39 is subjected to a data conversion process for the display device 40 of the operations panel P and output to the display control unit 36. The input control signal in accordance with function settings and inputting operations by an operator through the operations panel P is subjected to a data conversion process to suit the specifications of the image processing unit section A and input to the control panel communication unit 39.

As described above, the storage device 34 stores an OS and application programs executed by the CPU 31. In this sense, the storage device 34 functions as a storage medium to store application programs. In the digital color complex machine 1, when the user turns on power, the CPU 31 starts the boot program in the memory unit 32, reads the OS from the storage device 34 into the RAM of the memory unit 32, and starts the OS. The OS starts programs, reads and stores information in accordance with the operations by the user. As a typical OS, Windows (Trade Mark), for example, is known. Operation programs running on such an OS are called application programs. The OS of the information processing unit section B may the same as that of information processing apparatuses (such as the server computer 3 and the client computers 4), namely, a universal OS (for example, Windows (Trade Mark)).

As described above, the digital color complex machine 1 of the embodiment has mounted therein the external media input/output device 9 such as a flexible disk drive apparatus, an optical disk drive apparatus, a MO drive apparatus, and a media drive apparatus that read or write program codes and image data from or in the storage medium M. Note that the storage medium M stores various program codes (control programs) of an OS, device drivers, various application programs, etc., and image data, and it refers to a flexible disk, a hard disk, an optical disk (CD-ROM, CD-R, CD-RW, DVD-ROM, DVD-RAM, DVD-R, DVD+R, DVD-RW, DVD+RW, etc.), a magneto-optical disk (MO), a semiconductor media (SD memory card (Trade Mark), CompactFlash (Trade Mark), Memory Stick (Trade Mark), Smart Media (Trade Mark)), etc. The external media input/output device 9 is controlled by an input/output device control unit 42 connected to the CPU 31 through a bus.

Accordingly, the application programs stored in the storage device 34 may be installed from the recording medium M. In this sense, the storage medium M can serve as a storage medium that stores the application programs. Moreover, the application programs may be downloaded from the outside via, for example, the Internet network 6 and the LAN 2 and installed in the storage device 34.

Note that various interfaces 43 such as USB, IEEE 1394, and SCSI are also connected to the input/output device control unit 42, thereby allowing various equipment (such as digital cameras) to be connected to the digital color complex machine 1 via the various interfaces 43.

Next, a characteristic process executed by the digital color complex machine 1 is described. In the digital color complex machine 1, plural units that perform different processes, i.e., the image processing unit section A and the information processing unit section B as examples in the embodiment are allowed to independently perform their processes. Therefore, the digital color complex machine 1 can operate such that the image processing unit section A performs processing for scanning images while the information processing unit section B receives an email. In such an example, because the results of their processes do not influence each other, there is no problem even if the image processing unit section A and the information processing unit section B operate independently.

In addition, the digital color complex machine 1 can perform processing with respect to the results from the respective functions of the image processing unit section A by using the program operated in the information processing unit section B. For example, it is also possible to perform processing for recognizing the characters of document image data scanned by the image scanner 8 of the image processing unit section A using a predetermined application program so as to obtain a text document.

However, if the image processing unit section A and the information processing unit section B independently operate at all times, it is not possible to perform the processing with respect to the results from the respective functions of the image processing unit section A using the application program of the information processing unit section B. In order to deal with this, processing modules are combined with each other to operate the application program so that the respective functions of the image processing unit section A can be used.

In the image processing unit section A, the module of the control system executed in the image processing control unit 10 is composed of an application program for a control so that the original function of a complex machine is executed in the digital color complex machine 1. The digital color complex machine 1 provides the LAN control section 18 accessible from the information processing unit section B only via the HUB 19 (LAN 2) with the interface of an Internet-ready function module.

The Internet-ready function module allows functions such as the scanner function and the facsimile function, which are provided in a general complex machine as standard functions and executed by the image processing control unit 10, to be used via the LAN 2, and it cannot be operated even from the image processing unit section A.

The Internet-ready function module activates the processing module of a corresponding function when a transmission control protocol/Internet protocol (TCP/IP) constantly monitoring the access from the LAN 2 detects a connection request for a corresponding port number.

For example, when the connection request for the port number 1002 is made, the module of a facsimile reception function is activated. The activated module operates in cooperation with the processing request from a connection request source and provides a necessary response.

Next, the characteristics of the application programs of the information processing unit section B are described. As an example, a keyword generation application is described.

The keyword generation application performs processing for recognizing characters with respect to scanned image data and generates a keyword based on the results from recognizing the characters. In the entire information processing unit section B, the respective application programs operate under the control of the OS.

Furthermore, the respective application programs can use functions that the OS provides. In other words, the application programs are activated as modules that are software components so as to be used to perform necessary processing when they are executed. Examples of the modules include a TCP/IP control module. This executes a function included in the OS as a standard function to communicate with other information equipment sets connected by TCP/IP.

Furthermore, it is also possible to use independent application programs incorporated to be used for other application programs. For example, an OCR engine performs only processing for recognizing characters with respect to image data. The OCR engine does not operate singly, but it is used as a component (module) for other application programs.

Because the respective application programs can operate under the control of the OS in the entire information processing unit section B, it is possible to develop application programs in which the functions of the applications programs are used singly or combined with each other.

However, conventional techniques cannot directly use the functions of the image processing unit section A or the like in this way.

In other words, as described above, the digital color complex machine 1 is provided with the image processing unit section A that realizes the original function of a complex machine and the information processing unit section B that executes the application programs, and they are connected to each other via the LAN 2 by the network protocol (TCP/IP in this example) inside the digital color complex machine 1.

However, the image processing unit section A and the information processing unit section B can only be physically connected to each other. Therefore, data can be communicated between the image processing unit section A and the information processing unit section B, but the functions of the image processing unit section A cannot be performed by the application programs that operate in the information processing unit section B with conventional techniques.

Then, a description is now made of means for allowing the functions of the image processing unit section A to be performed by the application programs that operate in the information processing unit section B.

In the keyword generation application, for example, image data from which characters are to be recognized are image data scanned by the image scanner 8 managed in the image processing unit section A.

In order to instruct the image scanner 8 to scan images, it is necessary to specify the port number 1000 and request the image processing unit section A to make a TCP/IP connection. At the same time, data indicating the contents of processing are transmitted as a data stream. The function specified as the port number 1001 is to scan images with the image scanner 8 and transfer the scanned image data given any file name to the information processing unit section B. The contents of such processing are previously arranged, and port numbers are allocated to them so that the functions can be separately used.

In this manner, it is possible to perform the functions of the image processing unit section A using the keyword generation application. Note that communication protocols are not limited to TCP/IP, but other methods may be used.

(Example of the Functional Configuration of the Digital Color Complex Machine 1)

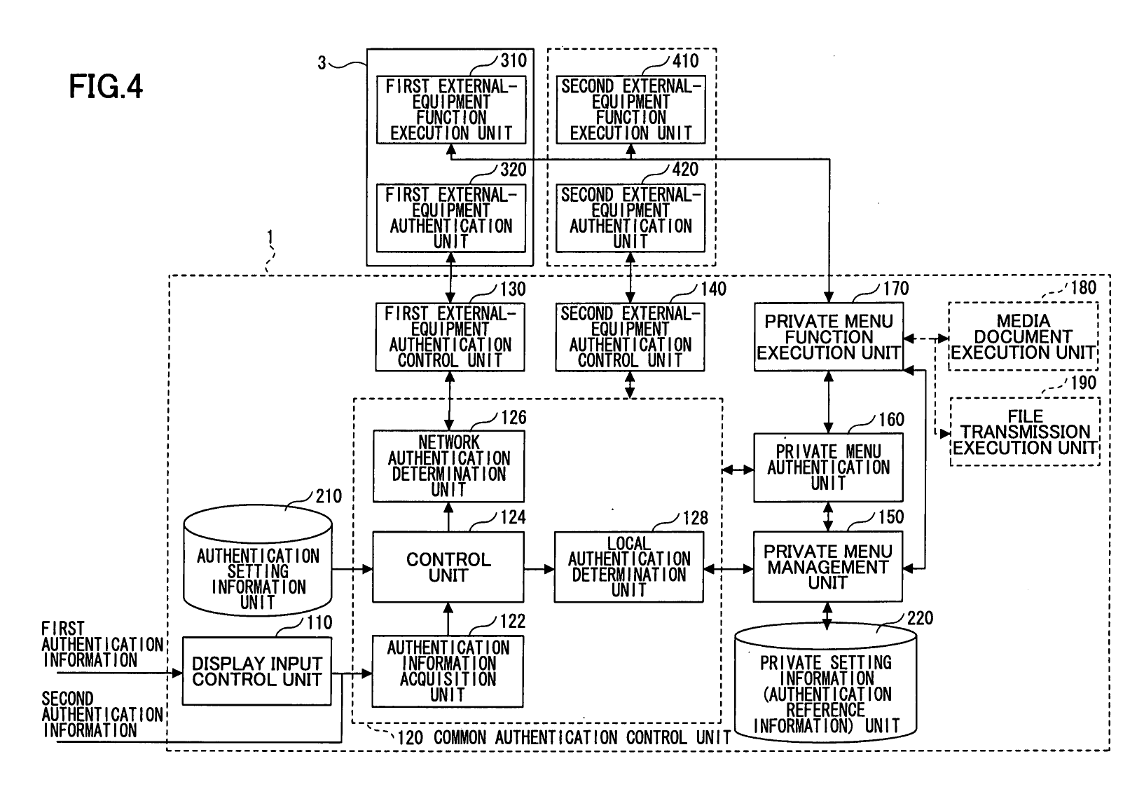

FIG. 4 is a block diagram showing the functional configuration of the digital color complex machine 1 in the embodiment. Note that arrows connecting respective units each other shown in FIG. 4 indicate the flows of representative signals, but they do not limit the functions of the respective units.

In FIG. 4, the digital color complex machine 1 includes a display input control unit 110, a common authentication control unit 120, a first external-equipment authentication control unit 130, a second external-equipment authentication control unit 140, a private menu management unit 150, a private menu authentication unit 160, a private menu function execution unit 170, a media document execution unit 180, a file transmission execution unit 190, an authentication setting information unit (authentication setting information storage unit) 210, a private setting information (authentication reference information) unit (private setting information storage unit) 220, and the like.

Furthermore, the common authentication control unit 120 includes an authentication information acquisition unit 122, a control unit 124, a network authentication determination unit 126, a local authentication determination unit 128, and the like.

The display input control unit 110 performs control related to various displays and inputs. For example, it has a function as an authentication information input unit for pressing a private authentication key from the main screen displayed on the operations panel P (see FIG. 3) and inputting authentication information of the user (a user name, a password, etc.) input through an input screen for authentication information.

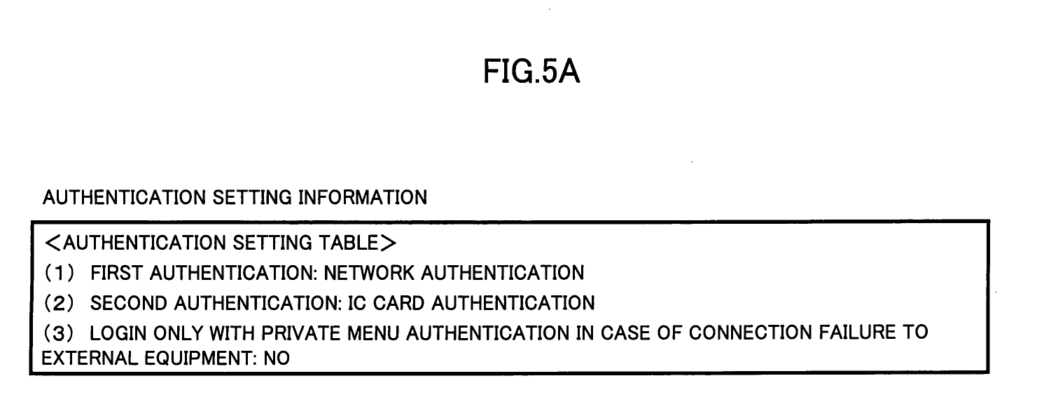

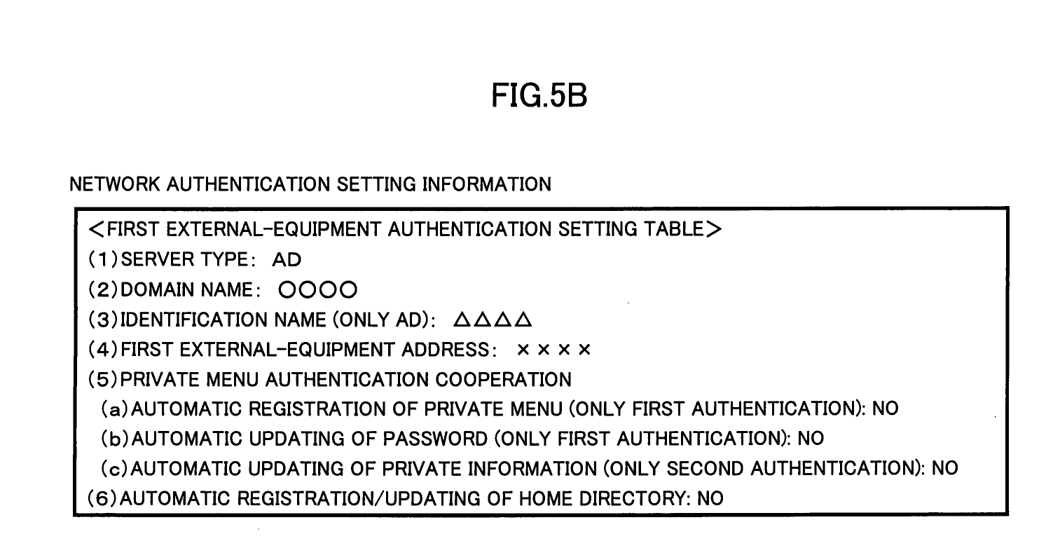

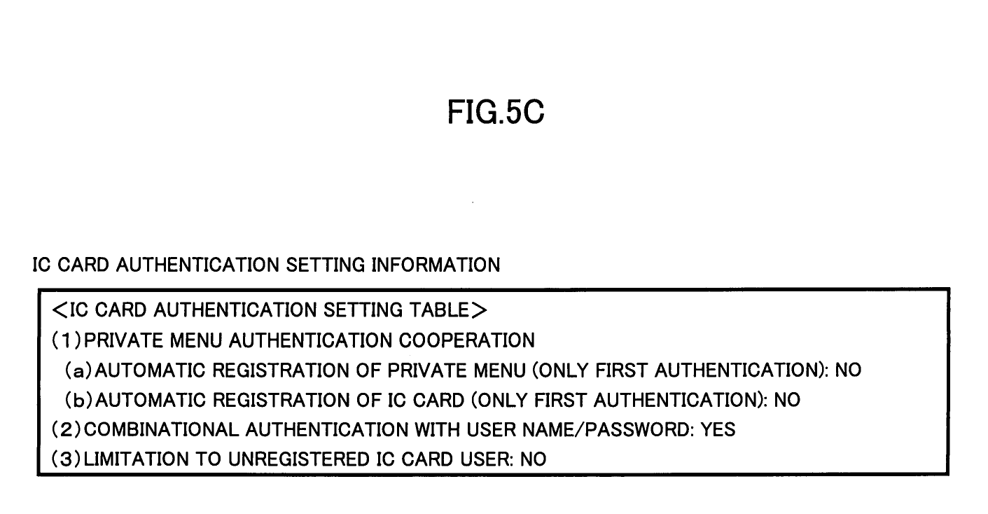

The common authentication control unit 120 performs control related to various authentications. Using, for example, authentication information input through the display input control unit 110, it performs control related to various authentications with the authentication information acquisition unit 122, the control unit 124, the network authentication determination unit 124, the local authentication determination unit 128, etc., in accordance with authentication setting information (see FIG. 5) stored in the below-described authentication setting information unit 210.

The authentication information acquisition unit 122 acquires authentication information. For example, it acquires authentication information such as a user name and a password input through the display input control unit 110. Furthermore, it acquires authentication information recorded on external storage media (such as an authentication IC card) using an external storage media reading/writing apparatus such as the IC card reader 45 (see FIG. 3). Furthermore, where the digital color complex machine 1 is provided with a function of performing biometrics authentication such as finger print authentication and vein authentication, it is also possible to acquire authentication information by reading the shapes of finger prints, palms, or blood vessels of fingers. Thus, the authentication information acquisition unit 122 acquires respectively input first authentication information such as a user name and a password and second authentication information different from the first authentication information recorded on the authentication IC card.

The control unit 124 controls various authentications based on authentication information acquired through the authentication information acquisition unit 122 in accordance with authentication setting information stored in the below-described authentication setting information unit 210. Specifically, it controls the various authentications using the below-described network authentication determination unit 126, the local authentication determination unit 128, etc.

The network authentication determination unit 126 determines success or failure of network authentication performed by the external equipment (e.g., the server computer 3 in FIG. 1) connected via a network. For example, it determines the success or failure of the network authentication by transmitting the authentication information acquired through the authentication information acquisition unit 122 to the external equipment via the below-described first external equipment authentication control unit 130 and receiving information related to the success or failure of the network authentication based on the authentication information from the external equipment.

The local authentication determination unit 128 determines success or failure of authentication in the digital color complex machine 1. For example, it determines the success or failure of the authentication by comparing the authentication information acquired through the authentication information acquisition unit 122 with authentication reference information stored in the below-described private setting information unit 220.

The first external-equipment authentication control unit 130 performs control related to authentication in the first external equipment 3 (e.g., the server computer 3 in FIG. 1). For example, it performs control related to the authentication by transmitting the authentication information acquired through the authentication information acquisition unit 122 to the first external equipment 3 and receiving information related to success or failure of authentication based on the authentication information from the first external equipment 3.

The second external-equipment authentication control unit 140 performs control related to authentication in second external equipment 4 (the digital color complex machine 1). Here, the functions provided in the digital color complex machine 1 are divided into two functions, i.e., private menu functions provided for each user of the digital color complex machine 1 and other functions (e.g., common functions such the scanner function and the copy function of the digital color complex machine 1). In the embodiment, the equipment having the latter functions is identified as the second external equipment 4. Similarly to the first external equipment, the second external equipment 4 may have a configuration as equipment different from the digital color complex machine 1 connected via a network.

The private menu management unit 150 manages private setting information stored in the below-described private setting information unit 220. The private menu authentication unit 160 performs authentication related to the use of the private menu functions provided for each user of the digital color complex machine 1. For example, it performs the authentication by comparing the authentication information acquired through the authentication information acquisition unit 122 with authentication reference information stored in the private setting information unit 220.

If the authentication in the private menu authentication unit 160 is successful, the private menu function execution unit 170 calls the private setting information stored in the private setting information unit 220 via the private menu management unit 150 to start a private menu under private settings. The media document execution unit 180 is an example of the private menu functions, which executes various processes like reading and writing of documents from and in a medium such as a MultiMedia Card (Trade Mark) connected, for example, to the external media input/output device 9 (see FIG. 2). The file transmission execution unit 190 is an example of the private menu functions, which executes transmission of files, for example, to the equipment connected via a network.

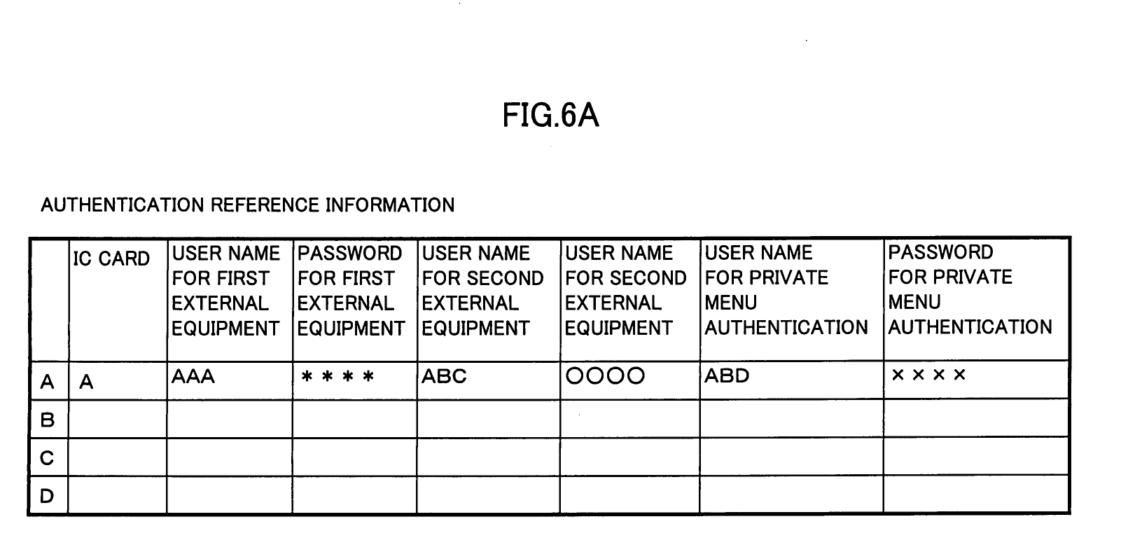

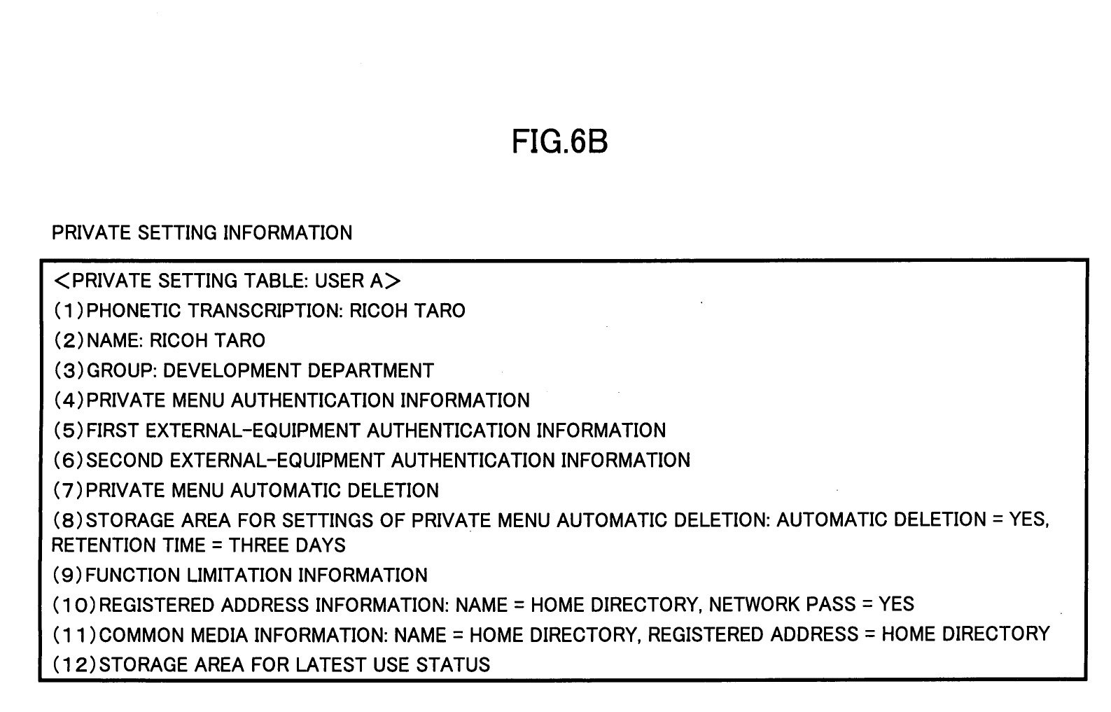

The authentication setting information unit 210 stores authentication setting information related to the authentication in the digital color complex machine 1. An example of the authentication setting information is described below with reference to FIG. 5. The private setting information unit 220 stores the private setting information (including authentication reference information for authentication of authentication information) in the digital color complex machine 1. An example of the private setting information is described below with reference to FIG. 6.

With the configurations of the above functions, the digital color complex machine 1 performs the authentication of the digital color complex machine 1, the first and second external equipment, etc. If the authentication is successful, the functions provided in the respective equipment sets are made available.

(Examples of Authentication Setting Information)

FIGS. 5A through 5C are tables showing examples of authentication setting information stored in the authentication setting information unit. Here, an example of the authentication setting information stored in the authentication setting information unit 210 in FIG. 4 is described.

FIG. 5A shows an example of a private menu authentication setting table for authentication related to a private menu in the digital color complex machine 1. In FIG. 5A, the items of “first authentication,” “second authentication,” and “login only with private menu authentication in case of connection failure to external equipment” are set.

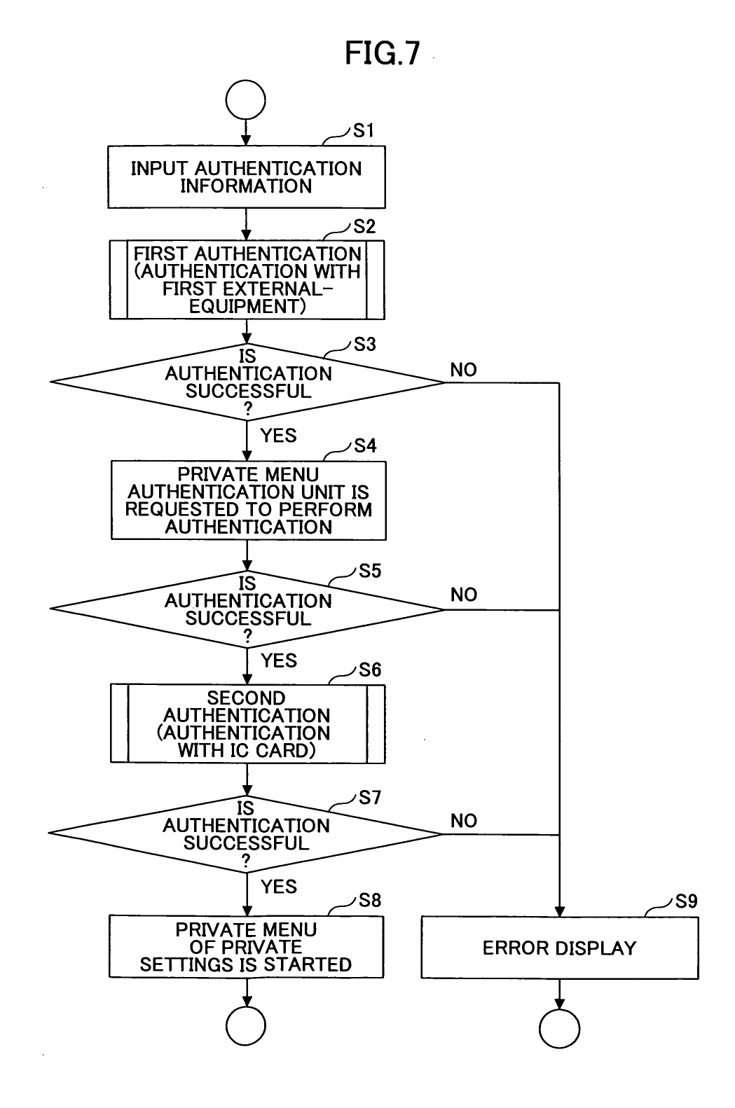

In the digital color complex machine 1 of the embodiment, the first authentication and the second authentication are performed in this order, and if both of the authentications are successful, it is made possible to login to the private menu prepared for the user. Here, the first authentication is authentication for determining the private menu and the second authentication is authentication for improving security. Detailed authentication operations are described below with reference to FIG. 7, etc. Moreover, the digital color complex machine 1 is configured to perform background authentication (called MFP authentication) after the first and second authentication, thereby making it possible to perform three complex authentications.

FIG. 5A shows an example in which the network authentication and IC card authentication (authentication based on an IC card) are set to the “first authentication” and the “second authentication,” respectively. At this time, the network authentication and the IC card authentication are performed in this order, and if both of the authentications are successful, the user is allowed to login to the private menu. Conversely, when the IC card authentication and the network authentication are set to the “first authentication” and the “second authentication,” respectively, the IC card authentication and the network authentication are performed in this order. Note, however, that authentication modes, which can be set to the “first authentication” and the “second authentication,” are not limited to the network authentication and the IC card authentication. They can be set in accordance with authentication modes provided in the digital color complex machine 1.

Furthermore, the item of “login only with private menu authentication in case of connection failure to external equipment” is to determine whether login is made only with private menu authentication of the private menu authentication unit 160 (see FIG. 4) in a case where the digital color complex machine 1 cannot be connected to external equipment connected via a network due, for example, to network trouble.

Accordingly, if the authentication has been successful with the network authentication, the user is allowed to login only with the private menu authentication in case of connection failure to a server. Note that if setting information related to the below-described network authentication is changed, the history of the successful authentication may be deleted.

FIG. 5B shows an example of a first external-equipment authentication setting table as setting information related to the network authentication (the network authentication with respect to the first external equipment 3) in the digital color complex machine 1. In FIG. 5B, the items of the setting information related to the first external equipment 3 such as “server type,” “domain name,” “identification name,” and “first external-equipment address” as well as “private menu authentication cooperation” and “automatic registration/updating of home directory” are set.

The “private menu authentication cooperation” is setting information related to the cooperation between the network authentication and the private menu authentication. The respective items of the private menu authentication cooperation are briefly described below.

In the “automatic registration of private menu (only the first authentication),” a setting is made whether the private menu is automatically registered with authentication information used for the network authentication. In the “automatic updating of password (only the first authentication),” a setting is made whether the password used for authentication of the private menu is automatically updated with the password used for the network authentication. In the “automatic updating of private information (only the second authentication),” a setting is made whether the authentication information used for authentication of the private menu is automatically updated with the authentication information used for the network authentication.

The “automatic registration/updating of home directory” is information for setting whether a common medium called a “home directory” is automatically registered/updated in accordance with home directory settings of the first external equipment 3.

As described above, in the case of the network authentication, the “automatic registration of private menu (only the first authentication),” the “automatic updating of password (only the first authentication),” the “automatic updating of private information (only the second authentication),” and the “automatic registration/updating of home directory (the first and second authentication)” can be performed.

FIG. 5C shows an example of an IC card authentication setting table for the IC card authentication in the digital color complex machine 1. In FIG. 5C, the items of “private menu authentication cooperation,” “combinational authentication with user name/password,” and “limitation to unregistered IC card user” are set.

The “private menu authentication cooperation” is setting information related to the cooperation between the IC card authentication and the private menu authentication. The respective items of the “private menu authentication cooperation” are briefly described below.

In the “automatic registration of private menu (only the first authentication),” a setting is made whether the private menu is automatically registered with the authentication information used for the IC card authentication when an unregistered IC card is read in the digital color complex machine 1 at the time of authentication. In the “automatic registration of IC card (only the first authentication),” a setting is made whether the user is prompted to input user name/password information when an unregistered IC card is read in the digital color complex machine 1 at the time of authentication and the IC card of the user who has succeeded in the authentication based on the input user name/password information is automatically registered.

In the “combinational authentication with user name/password,” it is possible to perform authentication with either an IC card or a user name/password.

In the “limitation to unregistered IC card user,” a setting is made whether authentication is allowed only for the authentication based on an unregistered IC card in the digital color complex machine 1 at the time of authentication.

As described above, in the case of the IC card authentication, the “automatic registration of private menu (only the first authentication),” the “automatic registration of IC card (only the first authentication),” and the “combinational authentication with user name/password (the first and second authentication)” can be performed. Furthermore, the user can be limited to an unregistered IC card user.

Moreover, where the IC card authentication and the network authentication are set to the “first authentication” and the “second authentication,” respectively, the private menu is automatically registered using the user name of an IC card number and then private information is updated in the network authentication, thereby making it possible to automatically change the user name of the IC card number to the user name in the network authentication.

(Example of Private Setting Information (Authentication Reference Information))

FIGS. 6A and 6B are tables showing private setting information stored in the private setting information unit. Here, an example of private setting information stored in the private setting information unit 220 in FIG. 4 is described.

FIG. 6A shows an example of authentication reference information for authentication of authentication information acquired by the digital color complex machine 1. In FIG. 6A, the items of “IC card,” “user name for private menu authentication,” “password for private menu authentication,” “user name for first external equipment,” “password for first external equipment,” “user name for second external equipment,” and “password for second external equipment” are set for each user of the digital color complex machine 1 so as to correspond to each other. Detailed description thereof is made below with reference to FIG. 7, etc. Here, the respective items are briefly described.

The “IC card” is information for authentication of authentication information recorded on an IC card. The “user name for private menu authentication” and the “password for private menu authentication” are authentication reference information for authentication with the private menu authentication unit 160 (see FIG. 4). The “user name for first external equipment” and the “password for first external equipment” are authentication information for authentication with the first external equipment 3 (see FIG. 4). The “user name for second external equipment” and the “password for second external equipment” are authentication information for authentication with the second external equipment (see FIG. 4).

FIG. 6B shows an example of a private setting table managed in the digital color complex machine 1. On the private setting table in FIG. 6B, the items of “phonetic transcription,” “name,” “group,” “private menu authentication information,” “first external-equipment authentication information,” “second external-equipment authentication information,” “private menu automatic deletion,” “storage area for settings of private menu automatic deletion,” “function limitation information,” “registered address information,” “common media information,” and “storage area for latest use status” are set for each user (user A as an example here) as the private setting information.

(First Example of Authentication Operation of the Digital Color Complex Machine 1)

FIG. 7 is a flowchart showing a first example of the authentication operation of the digital color complex machine 1 in the embodiment. Referring to the functional block diagram in FIG. 4, a description is now made of the operation of the digital color complex machine 1 where the network authentication and the IC card authentication are set to the “first authentication” and the “second authentication,” respectively, on the private menu authentication setting table in FIG. 5A.

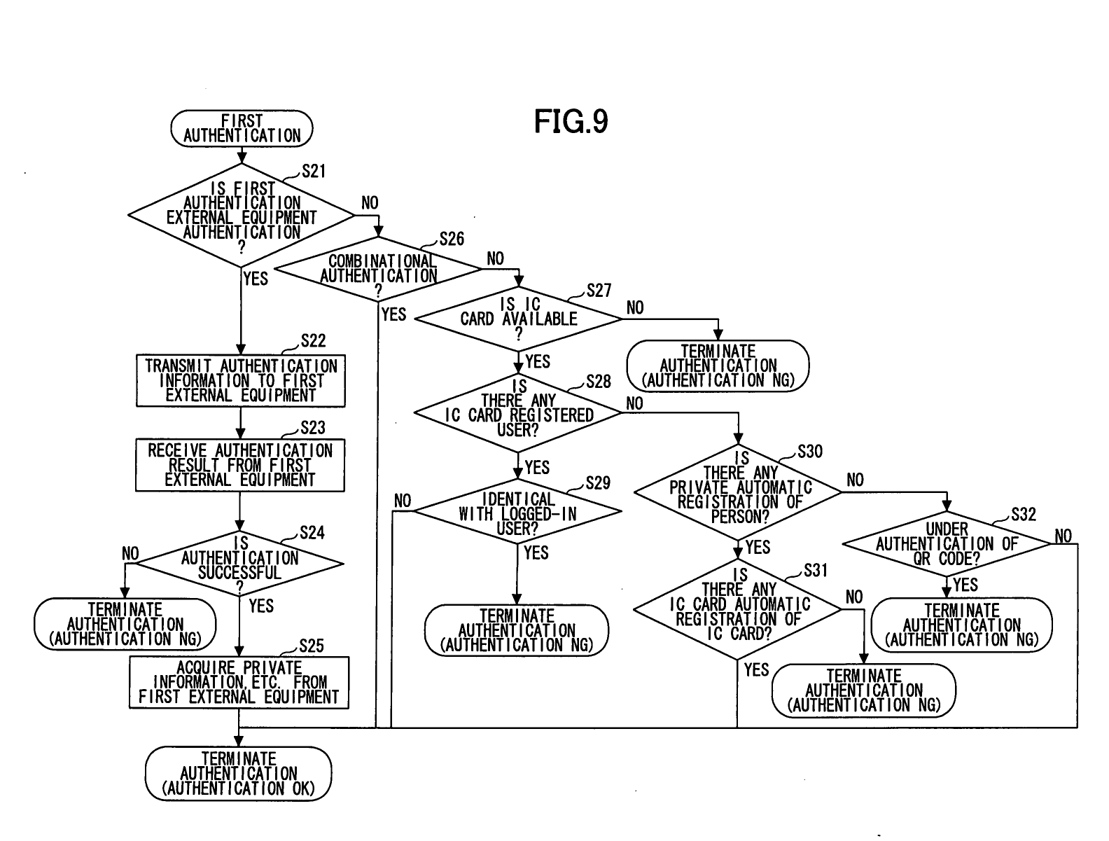

First, authentication information is acquired (S1). In step S1, the authentication information acquisition unit 122 acquires the authentication information such as a user name and a password input through the display input control unit 110. Then, the process proceeds to step S2 where the first authentication (the authentication with the first external equipment 3) is performed (S2). Here, the control unit 124 causes the network authentication determination unit 126 to perform the authentication in accordance with the authentication setting information (here, the network authentication is set to the “first authentication”) stored in the authentication setting information unit 210. Note that the detailed description of the first authentication is omitted here as it can be referred to in FIG. 9.

The process proceeds next to step S3 where it is determined whether the authentication is successful (S3). Here, the network authentication determination unit 126 determines the success or failure of the first authentication performed in step S2. Specifically, it determines the success or failure of the first authentication by transmitting the authentication information acquired in step S1 to the first external equipment 3 via the first external equipment authentication control unit 130 and then receiving information related to the success or failure of the authentication based on the authentication information from the first external equipment 3.

If it is determined that the authentication is successful in step S3 (YES in S3), the process then proceeds to step S4. If it is determined that the authentication fails (NO in S3), the process then proceeds to step S9 where error display is made to terminate the process.

If the process proceeds to step S4, the private menu authentication unit 160 is requested to perform the authentication (S4). Here, the control unit 124 (the common authentication control unit 120) requests the private menu authentication unit 160 to perform the authentication.

The process proceeds next to step S5 where it is determined whether the authentication is successful (S5). Here, the private menu authentication unit 160 requested to perform the authentication in step S4 performs the authentication using the authentication reference information stored in the private setting information unit 220 as well as the user name and the password acquired in step S1. Accordingly, information related to the user having just input the authentication information in the digital color complex machine 1 is determined (extracted) from plural user data sets on the authentication reference information table in FIG. 6A.

If it is determined that the authentication is successful in step S5 (YES in S5), the process then proceeds to step S6. If it is determined that the authentication fails (NO in S5), the process then proceeds to step S9 where the error display is made to terminate the process.

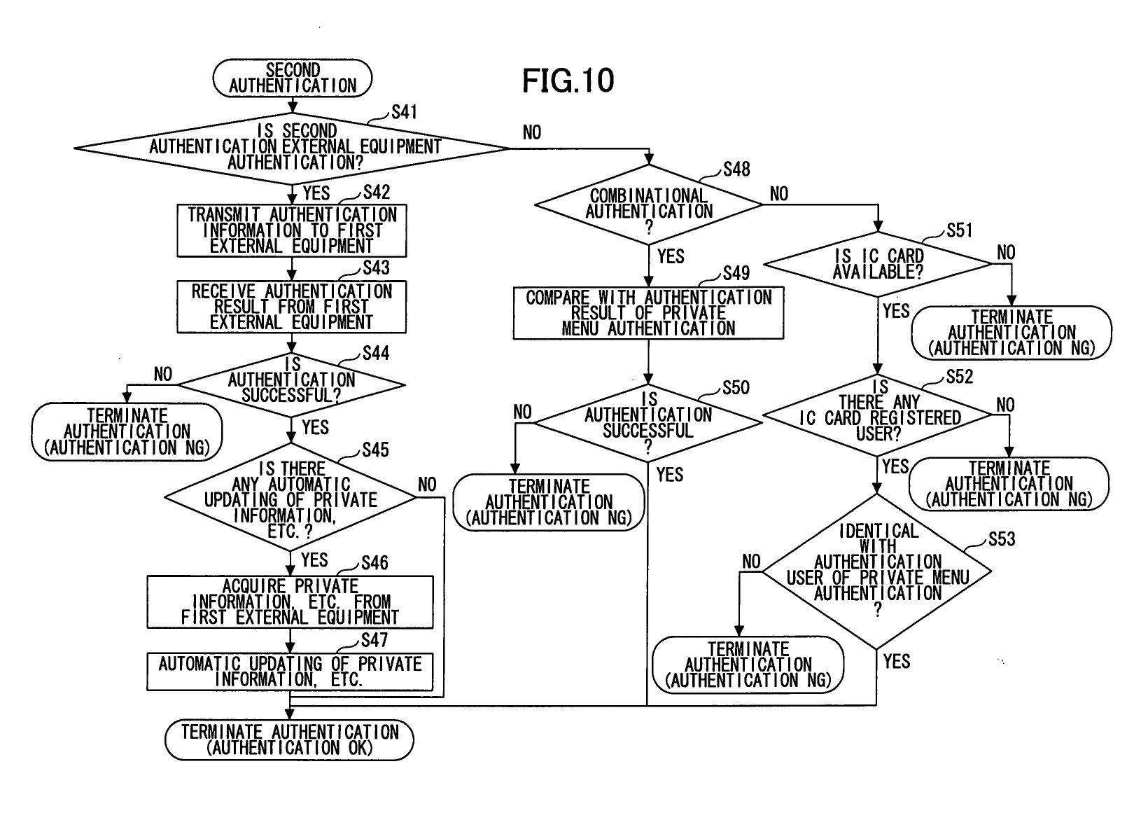

If the process proceeds to step S6, the second authentication (the IC card authentication) is performed (S6). Here, the authentication information acquisition unit 122 acquires the authentication information recorded on the IC card by using the IC card reader 45 (see FIG. 3). Moreover, the control unit 124 causes the local authentication determination 128 to perform the authentication in accordance with the authentication setting information (here, the IC card authentication is set to the “second authentication”) stored in the authentication setting information unit 210. Note that the detailed description of the second authentication is omitted here as it can be referred to in FIG. 10.

The process next proceeds to step S7 where it is determined whether the authentication is successful (S7). Using the authentication information recorded on the IC card acquired in step S6, the local authentication determination unit 128 performs the authentication with the information in the column “IC card” of the user determined to have just input the authentication information in the digital color complex machine 1 in step S5 on the authentication reference information table in FIG. 6A. Note that if the information on the “IC card” is not present, the authentication reference information for authentication of the authentication information recorded on the IC card acquired in step S6 may be registered/updated.

If it is determined that the authentication is successful in step S7 (YES in S7), the process then proceeds to step S8. If it is determined that the authentication fails (NO in S7), the process then proceeds to step S9 where the error display is made to terminate the process.

If the process proceeds to step S8, the private menu of private settings is started (S8). Here, the private menu function execution unit 170 starts the private menu of the private settings for the user having just input the authentication information in the digital color complex machine 1.

The digital color complex machine 1 operates according to the processes described above where the network authentication and the IC card authentication are set to the “first authentication” and the “second authentication,” respectively, on the private menu authentication setting table in FIG. 5A.

(Second Example of Authentication Operation of the Digital Color Complex Machine 1)

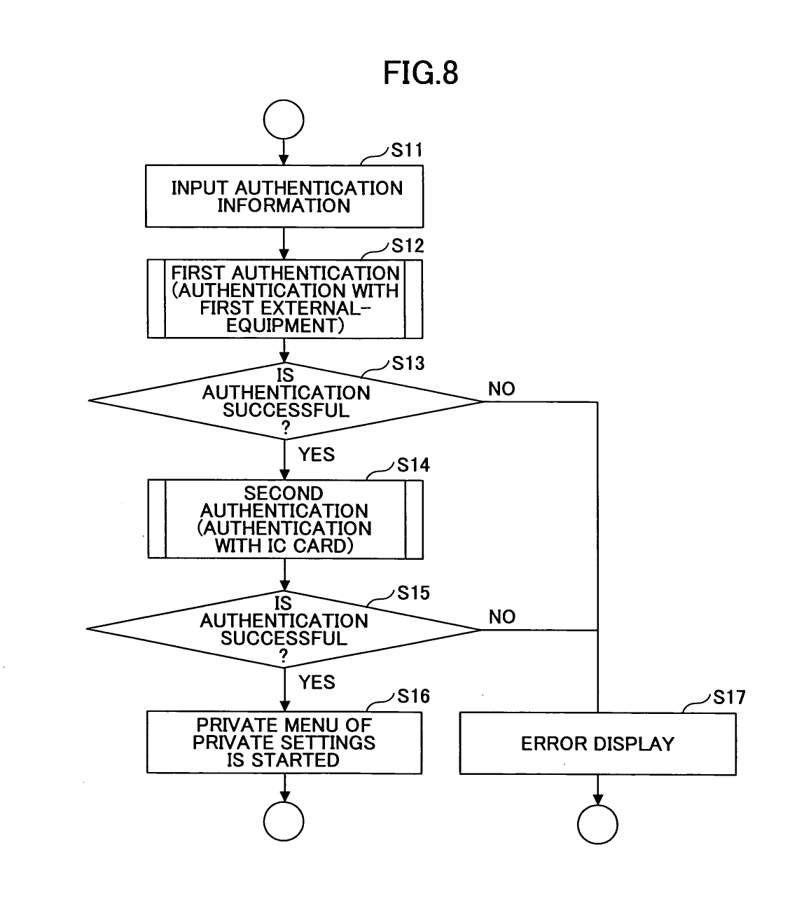

FIG. 8 is a flowchart showing a second example of the authentication operation of the digital color complex machine 1 in the embodiment.

Referring to the functional block diagram in FIG. 4, a description is now made of the operation of the digital color complex machine 1 where the IC card authentication and the network authentication are set to the “first authentication” and the “second authentication,” respectively, on the private menu authentication setting table in FIG. 5A.

First, authentication information is acquired (S11). In step S11, the authentication information acquisition unit 122 acquires the authentication information recorded on an IC card using the IC card reader 45 (see FIG. 3). Then, the process proceeds to step S12 where the first authentication (the IC card authentication) is performed (S12). Here, the control unit 124 causes the local authentication determination unit 128 to perform the authentication in accordance with the authentication setting information (here, the IC card authentication is set to the “first authentication”) stored in the authentication setting information unit 210. Note that the detailed description of the first authentication is omitted here as it can be referred to in FIG. 9.

The process proceeds next to step S13 where it is determined whether the authentication is successful (S13). Here, the local authentication determination unit 128 determines the success or failure of the first authentication performed in step S12. Specifically, it determines the success or failure of the first authentication by comparing the authentication information acquired in step S1 with the authentication reference information stored in the private setting information unit 220. Accordingly, information related to the user having just input the authentication information in the digital color complex machine 1 is determined (extracted) from plural user data sets on the authentication reference information table in FIG. 6A.

If it is determined that the authentication is successful in step S13 (YES in S13), the process then proceeds to step S14. If it is determined that the authentication fails (NO in S13), the process then proceeds to step S17 where the error display is made to terminate the process.

If the process proceeds to step S14, the second authentication (the authentication with the first external equipment 3) is performed (S14). In accordance with the authentication setting information (here, the network authentication is set to the “second authentication”) stored in the authentication setting information unit 210, the control unit 124 performs the authentication with the information in the columns “user name for first external equipment” and “password for first external equipment” of the user determined to have just input the authentication information in the digital color complex machine 1 in step S11 on the authentication reference information table in FIG. 6A. Specifically, the network authentication determination unit 126 transmits the “user name for first external equipment” and the “password for first external equipment” to the first external equipment 3 via the first external equipment authentication control unit 130. The first external equipment 3 performs the authentication based on the received authentication information and transmits information related to the success or failure of the authentication to the network authentication determination unit 126. Note that the detailed description of the second authentication is omitted here as it can be referred to in FIG. 10.

The process then proceeds to step S15 where it is determined whether the authentication is successful (S15). Here, the local authentication determination unit 128 makes a determination whether it is successful using the information related to the success or failure of the authentication acquired in step S15.

If it is determined that the authentication is successful in step S15 (YES in S15), the process then proceeds to step S16. If it is determined that the authentication fails (NO in S15), the process then proceeds to step S17 where the error display is made to terminate the process.

If the process proceeds to step S16, the private menu of private settings is started (S16). Here, the private menu function execution unit 170 starts the private menu of the private settings for the user having just input the authentication information in the digital color complex machine 1.

The digital color complex machine 1 operates according to the processes described above where the IC card authentication and the network authentication are set to the “first authentication” and the “second authentication,” respectively, in the private menu authentication setting table in FIG. 5A.

Accordingly, even where the digital color complex machine 1 is shared by plural users, it is possible to simplify the authentication operations. Particularly, where the digital color complex machine 1 is shared by plural users, the digital color complex machine 1 performs the authentication based on the authentication information acquired from external storage media when the users are switched. Thus, it is not necessary to input the first authentication information with the operations unit every time the users are switched. Furthermore, this makes it possible to reduce information leakage compared with the authentication with a user name/password.

Furthermore, because the digital color complex machine 1 has the first external equipment authentication control unit 130, the server computer 3 as external equipment is not required to have the first external equipment authentication control unit 130. In other words, it is possible to easily additionally install the digital color complex machine 1 in a network without modifying the functions of the external equipment.

Note that it is possible to perform the IC card authentication at the time of scanning an authentication QR code. When a sheet document is mounted on an automatic document feeder (ADF) and processing is started, the user is required to perform the authentication. In this case, the user is just required to hold the IC card over an IC card reader to execute operations.

Furthermore, at the time of registering an IC card, it is possible to automatically add the IC card to a list of IC card use limitations so that it is authorized. If this list is made unavailable, the authorization and registration of the IC card cannot be performed at all. This action is taken in the event that the IC card is lost or illegally used.

(Additional Features)

According to the embodiment, the information processing system having a function used when the authentication is successful is provided. The system can be configured to have an authentication information acquisition unit that acquires a password and IC card storage information; an authentication information storage unit that stores password reference information for authentication of the password and IC card reference information for authentication of the IC card storage information; a password authentication determination unit that determines success or failure of password authentication based on the password in accordance with the password and the password reference information; an IC card authentication determination unit that determines success or failure of IC card authentication based on the IC card storage information in accordance with the IC card storage information and the IC card reference information; and an authentication information control unit that stores the password in the authentication information storage unit so as to correspond to the IC card reference information when the password authentication and the IC card authentication are successful at the same time.

Accordingly, it is possible to achieve the following effects. For example, assume that it is desired to change an authentication method from the authentication with a password to the IC card authentication where the password authentication has been performed. If the password authentication and the IC card authentication are both successful, the password is stored corresponding to the IC card reference information. Thus, if the IC card authentication is successful at the next authentication, it is possible to automatically read the password stored in the information processing system without inputting the password. Accordingly, the password authentication is automatically successful based on the read password and the password reference information.

After storing the password corresponding to the IC card reference information, the digital color complex machine 1 per se performs the password authentication subsequently to the IC card authentication to make the functions of the apparatus corresponding to the password authentication available. In other word, the information processing system per se performs both of the password authentication and the IC card authentication. If this is viewed from the side of the user, on the other hand, it seems that the user is allowed to use the functions of the information processing system corresponding to the password authentication by inputting with the IC card without inputting the password. That is, from the viewpoint of the user, the authentication method is changed from the password authentication to the IC card authentication.

As described above, a simple operation of making the password authentication and the IC card authentication successful at the same time (without previously registering the correspondence between the password authentication and the IC card authentication in the information processing system) makes it possible to change the authentication method from the password authentication to the IC card authentication.

Furthermore, according to the information processing system of the embodiment, the authentication information control unit can be configured to generate information corresponding to IC card storage information as the IC card reference information and store it in the authentication information storage unit when the authentication information acquisition unit acquires the IC card storage information in a case where the authentication information storage unit does not store the IC card reference information.

Thus, when the IC card storage information is input for the first time, the IC card reference information is automatically generated and stored in the information processing system. Therefore, when the IC card storage information is input for the first time, the IC card authentication is automatically performed (without previously registering the IC card reference information in the information processing system).

Accordingly, even where the IC card storage information is input for the first time, the password authentication and the IC card authentication can be successful at the same time, thereby making it possible to change the authentication method from the password authentication to the IC card authentication with a simple operation.

Furthermore, according to the information processing system of the embodiment, the password authentication determination unit can be configured to perform the password authentication based on either the read password corresponding to the IC card authentication reference information or the input password. Thus, after storing the correspondence between the password authentication and the IC card authentication, the information processing system can use one of the password authentication and the IC card authentication.

Furthermore, according to the information processing system of the embodiment, the password authentication determination unit can be configured such that the authentication information storage unit does not perform the authentication based on the input password where the password is stored corresponding to the IC card authentication reference information.

Thus, after storing the correspondence between the password authentication and the IC card authentication, the information processing system does not perform the password authentication, but can use only the IC card authentication.

Furthermore, according to the information processing system of the embodiment, the authentication information control unit can be configured to store the function added during the password authentication in the authentication information storage unit so as to correspond to the password authentication reference information. Furthermore, after the authentication method is changed from the password authentication to the IC card authentication, the function (private registration function) added during the password authentication can be used as it is during the IC card authentication.

In other words, even after the authentication method is changed from the password authentication to the IC card authentication, the information processing system per se performs the operations in the order of the IC card authentication, the password authentication, and the use of the functions. Therefore, there is no change in that the function added during the password authentication is used.

However, it seems from the user side that the function added during the password authentication can be made available during the IC card authentication.

(Supplemental Features)

Furthermore, according to the embodiment, the information processing system is provided that includes an information processing apparatus and a server connected to the information processing apparatus via a network. The system can be configured to have a password authentication information storage unit that is included in the authentication information storage unit and stores the password authentication reference information; and the password authentication determination unit. The information processing apparatus comprises the authentication information acquisition unit; a second authentication information storage unit that is included in the authentication information storage unit and stores the IC card authentication reference information and the password corresponding to the IC card authentication reference information; a second authentication determination unit; and the authentication information control unit.

Thus, it is not necessary to previously register the correspondence between the password authentication and the IC card authentication. In other words, a simple operation is performed of making the password authentication and the IC card authentication successful on the side of the information processing apparatus without changing the function of the server, thereby making it possible to change the authentication method from the password authentication to the IC card authentication.

Furthermore, according to the embodiment, the information processing apparatus is provided that is connected to external equipment for determining success or failure of authentication via a network and can use the function of the external equipment when the authentication is successful. The apparatus can be configured to have an authentication information acquisition unit that acquires first authentication information and second authentication information different from the first authentication information; a transmission and reception unit that transmits the first authentication information to the external equipment and receives information related to success or failure of first authentication based on the first authentication information from the external equipment; an authentication information storage unit that stores second authentication reference information for authentication of the second authentication information; a second authentication determination unit that determines success or failure of second authentication based on the second authentication information in accordance with the second authentication information and the second authentication reference information; and an authentication information control unit that stores the first authentication information in the authentication information storage unit so as to correspond to the second authentication reference information when the first and second authentications are successful.

Furthermore, according to the embodiment, the information processing apparatus having a function used when authentication is successful is provided. The apparatus can be configured to have an authentication information acquisition unit that acquires first authentication information and second authentication information different from the first authentication information; an authentication information storage unit that stores first authentication reference information for authentication of the first authentication information and second authentication reference information for authentication of the second authentication information; a first authentication determination unit that determines success or failure of first authentication based on the first authentication information in accordance with the first authentication information and the first authentication reference information; a second authentication determination unit that determines success or failure of second authentication based on the second authentication information in accordance with the second authentication information and the second authentication reference information; and the authentication information control unit that stores the first authentication information in the authentication information storage unit so as to correspond to the second authentication information when the first and second authentications are successful at the same time.

The present invention is not limited to the specifically disclosed embodiments, and variations and modifications may be made without departing from the scope of the present invention.

The present application is based on Japanese Priority Application No. 2007-169791 filed on Jun. 27, 2007, the entire contents of which are hereby incorporated herein by reference.

What is claimed is:

1. An information processing system having a function used when authentication is successful, the system comprising:
an authentication information acquisition unit that acquires first authentication information and second authentication information different from the first authentication information;
an authentication reference information storage unit that stores first authentication reference information for authentication of the first authentication information and second authentication reference information for authentication of the second authentication information;
a first authentication determination unit that determines success or failure of first authentication using the first authentication information and the first authentication reference information;
a second authentication determination unit that determines success or failure of second authentication using the second authentication information and the second authentication reference information; and
an authentication information control unit that stores the second authentication reference information and the first authentication information in the authentication reference information storage unit so as to correspond to each other when the first authentication and the second authentication are successful.

2. The information processing system according to claim 1, wherein, when the second authentication information is acquired by the authentication information acquisition unit in a case where the authentication reference information storage unit does not store the second authentication reference information,
the authentication information control unit stores information corresponding to the second authentication reference information generated based on the acquired second authentication information in the authentication reference information storage unit as the second authentication reference information.

3. The information processing system according to claim 1, wherein
the first authentication determination unit determines the success or failure of the first authentication based on one of the first authentication information acquired by the authentication information acquisition unit and the first authentication information stored in the authentication reference information storage unit corresponding to the second authentication reference information.

4. The information processing system according to claim 1, wherein
the first authentication determination unit prevents using the first authentication information acquired by the authentication information acquisition unit when the second authentication reference information and the first authentication information are stored in the authentication reference information storage unit so as to correspond to each other.

5. The information processing system according to claim 1, wherein
the authentication information control unit stores a function added during the first authentication in the authentication information storage unit so as to correspond to the first authentication reference information.

6. The information processing system according to claim 1 that includes an information processing apparatus and external equipment connected to the information processing apparatus via a network, wherein
the external equipment has a first authentication information storage unit that is included in the authentication information storage unit and stores the first authentication reference information; and
the first authentication determination unit, and
the information processing apparatus has the authentication information acquisition unit;
a first authentication information storage unit that is included in the authentication information storage unit and stores the first authentication reference information;
the second authentication determination unit; and
the authentication information control unit.

7. The information processing system according to claim 1, further comprising
an IC card reader for reading information recorded on an IC card, wherein
the first authentication information acquired by the authentication acquisition unit is authentication information recorded on the IC card.

8. The information processing system according to claim 7, wherein
the second authentication information acquired by the authentication acquisition unit is information of an input user name and/or a password.

9. An information processing apparatus that is connected to external equipment for determining success or failure of authentication via a network and can use a function of the external equipment when the authentication is successful, the apparatus comprising:
an authentication information acquisition unit that acquires first authentication information and second authentication information different from the first authentication information;
a transmission and reception unit that transmits the first authentication information to the external equipment and receives information related to success or failure of first authentication based on the first authentication information from the external equipment;
an authentication information storage unit that stores second authentication reference information for authentication of the second authentication information;
a second authentication determination unit that determines success or failure of second authentication using the second authentication information and the second authentication reference information; and
an authentication information control unit that stores the second authentication reference information and the first authentication information in the authentication reference information storage unit so as to correspond to each other when the first authentication and the second authentication are successful.

10. An information processing apparatus having a function used when authentication is successful, the apparatus comprising:
an authentication information acquisition unit that acquires first authentication information and second authentication information different from the first authentication information;
a first authentication determination unit that determines success or failure of first authentication using the first authentication information and first authentication reference information;
a second authentication determination unit that determines success or failure of second authentication using the second authentication information and second authentication reference information; and
an authentication information control unit that stores the second authentication reference information and the first authentication information in an authentication reference information storage unit so as to correspond to each other when the first authentication and the second authentication are successful.
